(19) United States
(12) Patent Application Publication
(10) Pub. No.: US 2010/0134765 A1
(43) Pub. Date: Jun. 3, 2010

(54) METHOD OF DRIVING A DISCHARGE LAMP IN A PROJECTION SYSTEM, AND DRIVING UNIT

(75) Inventors: Carsten Deppe, Aachen (DE); Tom Munters, Aachen (DE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/993,498

(22) PCT Filed: Jun. 23, 2006
(86) PCT No.: PCT/IB2006/052057

§ 371 Date: Dec. 30, 2009

(30) Foreign Application Priority Data
Jun. 30, 2005 (EP) 05105872.5

(51) Int. Cl. G03B 21/20

(52) U.S. Cl. 353/85; 353/121

(57) ABSTRACT

The invention describes a method of driving a discharge lamp (1) in a projection system (10), wherein, in a feed-forward control process, system status data (SD_{L}, SD_{F}, SD_{V}) comprising static information pertaining to the design of the system and/or dynamic information pertaining to the projection system and/or dynamic information pertaining to the lamp operation are obtained. Based on the system status data (SD_{L}, SD_{F}, SD_{V}), a momentary target light waveshape (LW_{T}, LW_{T′}) required by the projection system (10) and a waveshape correcting function are determined. Subsequently, the actual current (I) of the discharge lamp (1) is controlled regulated according to a momentary required waveshape (RW) which is determined based on the target light waveshape (LW_{T}, LW_{T′}) and the waveshape correcting function. Moreover the invention describes an appropriate driving unit (11) for driving a discharge lamp (1) and a projection system (10), comprising such a driving unit (11).

This invention relates to a method of driving a discharge lamp in a projection system. Furthermore, the invention relates to an appropriate driving unit for driving a discharge lamp in a projection system and to an projection system comprising such a driving unit.

Discharge lamps, particularly high pressure discharge lamps, comprise an envelope which consists of material capable of withstanding high temperatures, for example, quartz glass. From opposite sides, electrodes made of tungsten protrude into this envelope. The envelope, also called “arc tube” in the following, contains a filling consisting of one or more rare gases, and, in the case of a mercury vapour discharge lamp, mainly of mercury. By applying a high voltage across the electrodes, a light arc is generated between the tips of the electrodes, which can then be maintained at a lower voltage. Owing to their optical properties, high pressure discharge lamp, are preferably used, among others, for projection purposes. For such applications, a light source is required which is as point-shaped as possible. Furthermore, a luminous intensity—as high as possible—accompanied by a spectral composition of the light—as natural as possible—is desired. These properties can be optimally achieved with so called “high pressure gas discharge lamps” or “HID lamps” (High Intensity Discharge Lamps) and, in particular, “UHP-Lamps” (Ultra High Performance Lamps).

In particular when using gas discharge lamps in projection systems which apply a time sequential colour generation method for generating the colour images, it must be ensured that fluctuations do not arise in the generated luminous flux, since fluctuations in luminous flux could, in such systems, result in one of the primary colours being rendered with a different intensity than the other primary colours, or that its brightness in certain regions differs from the brightness in other regions.

At the present time, two kinds of time sequential colour generating method are distinguished:

In a first method, the colour image is generated by sequential representation of full pictures in the three primary colours (“field sequential colour”). Optionally, an additional fourth white image or additional other colours can be displayed. This method is used, for example, in most DLP® projectors (DLP=Digital Light Processing; DLP is a registered trademark of Texas Instruments®).

In a second method, the colour image is generated by having all primary colours pass over the display, one after the other, in the form of colour beams or colour strips (“scrolling colour”). For example, some LCoS displays (LCoS=Liquid Crystal on Silicon) operate using this method.

The systems comprise a colour separation or colour filtering, and a modulator for the colour components between the light source and the display so as to generate light in the three primary colours. The colour separation and the modulator may be mutually integrated to a more or less great extent. For example, in some systems, filtering and modulation are carried out by a rotating filter wheel, whereas in other systems the colour filtering takes place by means of mirrors, and the modulation by means of prisms.

In more up-to-date projection systems which use time sequential colour generation, strict requirements apply for the light output of the lamp. Recent developments are moving in the direction of using the possibilities that arise from a modulation of the light output to improve the total brightness, increase the grey-scale resolution, and to balance the colour point of the image.

It is thus expedient, in balancing the colour point, to temporarily decrease the light power at certain precisely defined times, i.e. in certain colour bands, and to increase the light power at other times, i.e. for other colour bands. Furthermore, it is, for example, expedient to apply an additional current pulse—the “anti-flutter pulse”—at the end of each half-period, to ensure that the position of the light arc within the lamp remains as steady as possible.

To achieve these goals, the light emitted by the lamp must follow a precise curve during a half-period of the lamp, i.e. in a voltage half-period. Thereby, it must be ensured that the required values are met very precisely, in order to guarantee an optimal operation of such a projector system. Although the lamp power and the light output can be modulated relatively quickly, and the relationship between lamp current to light is about 1, the attainable performance with the present-day lamp drivers is not sufficient for applications requiring greater precision. This is because, among other things, the light output depends not only on several lamp properties which might also vary over the lifetime of the lamp, but also on the optical system design and the colour bands used for projection.

Therefore, an object of the present invention is to provide a method of driving a discharge lamp in a projection system, and an appropriate driving unit which allows a more precise control of the light according to the requirements of the projection system.

To this end, the present invention provides a method of driving a discharge lamp, operating in a feed-forward control process. In this process status data comprising static information pertaining to the design of the projection system and/or dynamic information pertaining to the projection system and/or dynamic information pertaining to the lamp operation are obtained. In a further step, based on the system status data, a “momentary” target light waveshape required by the projection system, i.e. an ideal light waveshape for the projection system and a waveshape correcting function are determined. Then, the actual current of the discharge lamp is regulated according to a momentary required waveshape which is determined based on the target light waveshape and the waveshape correcting function.

Here, the term “momentary waveshape” is intended to mean a particular segment of time for which the required light or the resulting required lamp current is calculated in advance with respect to time. For example, it might be an entire half-wave or part of a half-wave over the lamp current. In the case of DC operated lamps it can be any periodically repeated pulse sequence. It is thereby irrelevant, whether the regulation control is based on a required light waveshape or a required current waveshape, since it is ultimately the percentage change in current or light with respect to a normalised value for the waveshape that is important, whereby the normalising is carried out according to the required power. It is only important that the waveshape correcting function is taken into consideration. This means that is truly irrelevant whether, for example, a “fundamental current waveshape” is calculated based on the target light waveshape, differing only by a factor from the target light waveshape and which fundamental current waveshape can be converted to a required current waveshape with the aid of the waveshape correcting function in order to acquire the desired target light waveshape, or whether the target light waveshape is corrected with the aid of the waveshape correcting function, so that the current is regulated according to this corrected light waveshape. In both cases, a corresponding prior correction in the current regulation allows generation of the desired target light waveshape with the required precision. The method according to the invention therefore guarantees that an ideal light be generated with a precisely defined intensity curve in order to optimise the overall performance of the projection system.

An appropriate driving unit for driving a discharge lamp in a projection system by means of a feed-forward control process, according to the invention, must first comprise a source of system status data, which system status data comprise static information pertaining to the design of the projection system and/or dynamic information pertaining to the projection system and/or dynamic information pertaining to the lamp operation. Second the driving unit must comprise a pattern calculation unit for determination of a momentary target light waveshape required by the projection system and a lamp current correcting function based on the system status data. Furthermore the driving unit must comprise a current control unit for controlling the actual current of the discharge lamp according to a required waveshape which is determined based on the target light waveshape and the correcting function.

The dependent claims and the subsequent description disclose particularly advantageous embodiments and features of the invention.

Various parameter values, such as measurable values in the projection system, stored projection system configuration values or currently defined values can be used as system status data.

Preferably, a first type of system status data comprises data from the following data group: lamp voltage, electrode separation, electrode status, discharge arc attachment over time, gas pressure of the lamp (particularly mercury pressure, if the lamp is a mercury vapour lamp), etc. Thereby, the electrode status may, for example, comprise information whether the electrodes are hot, cold or molten. The discharge arc attachment over time may, for example, comprise information whether the discharge is diffuse, or whether there is a prominent spot, etc.

It is thereby sufficient to measure a sub-set of the above-mentioned values, and to derive or deduce the remaining values from the measured values.

The lamp voltage is, for example, characteristic for the electrode separation. This type of data also allows, in particular, determination of an indication of the light source etendue, because the arc length depends on the electrode separation.

Also, the lamp pressure can be estimated on the basis of the average lamp voltage, e.g. by measuring and noting the average lamp voltage in the preceding normal operation, and then checking to see whether the lamp voltage has dropped below a certain value, which value can be determined by multiplying the average voltage in normal operation by a certain factor. Furthermore, the lamp voltage and the lamp current may be monitored and analysed, and a property of a current-voltage characteristic of the lamp may determined to give an indication of the gas pressure in the arc tube. This method is particularly successful in the case of mercury vapour discharge lamps.

Preferably, a second type of system status data comprises information from the following group of variable system settings: positive and negative pulse timing, light level and colour band (in which the light level is required), assigned placement of anti-flutter pulse.

Preferably, a third type of system status data comprises information from the following group of fixed system settings: lamp type, reflector type, colour filter and/or modulator construction data, system etendue. The colour filter and/or modulator construction data are, for example, precise information pertaining to the colour filters used and, for example, the arrangement of the segments and spokes of a colour wheel, if a colour wheel is being used.

The system settings, i.e. the status data of the second and third types serve to determine the momentary required target light waveshape. The status data of the first type are used first and foremost for calculating the waveshape correcting function, whereby data of the second and third type may also be used for this. In particular, the correcting function can depend on the required lamp power.

A suitably equipped driving unit therefore preferably comprises, as the source of system status data, a lamp information unit for acquiring data pertaining to the momentary status of the lamp, a first storage means comprising fixed settings data of the projection system and a second storage means comprising variable settings data of the projection system. The first storage means and the second storage means can of course be realised as a single storage means. The driving unit also preferably comprises a suitable interface to acquire the settings, for example, from a higher-level control unit. Evidently, the storage means can also be realised outside of the driving unit, if the driving unit has access to such an external memory. Such an external memory is regarded as the driving unit memory if it has storage reserved for storing data for the driving unit.

Various possibilities are available for the definition of a suitable waveshape correcting function. For example, it is possible that the function is defined as a set of points in a look-up table, or similar. However, it is also possible to define the waveshape correcting function by means of suitable equations, at least in stages.

In one simple example, the rectification function can be as follows:

Lₜ=f(Iₜ)=kₜ·Iₜ (1)

i.e., the correcting function f(Iₜ) is obtained by scaling the current value Iₜ by a factor kₜ in order to obtain the required light waveshape for the light Lₜ at a certain time t.

A particular required lamp current can then be determined at a certain point in time within the defined time-span for which the waveshape is being calculated by dividing a value of the target light waveshape, valid for this time t, by the correcting factor kₜ valid at this time, as defined in equation (1).

Furthermore, such a function can be non-linear, i.e. it can be defined in any other form and can depend on a multitude of other parameters:

Lₜ=f(Iₜ, etendue, lamp type, d, p, electrode state, arc state, colour band) (2)

where d is the electrode separation, and p is the pressure in the discharge chamber. However, along with information pertaining to the required lamp power and timing, a linear relationship as in equation (1) can be substituted for a complex function for a particular time.

Various methods exist for determining the waveshape correcting function.

For example, one method involves determining experimental correcting values which are then used as sampling points in order to generate at least parts of the waveshape correcting function, for example segments thereof, or only for certain parameters. This method will be described in more detail below.

When using a step-wise correcting function defined in a look-up table, the corresponding correcting sample can be taken. Alternatively, such a correcting factor can be calculated from the relevant parameters upon which the correcting function depends and which are determined from the system status data. In the case of using a look-up table with individual sample points, this it the equivalent of an interpolation between the sample points for values that are not directly present in the look-up table.

For a preferred embodiment, relatively simple to realise, the correcting factors and/or at least parts of the waveshape correcting function are determined, according to the system parameters colour band, relative current or light level required in this colour band, momentary lamp voltage and system etendue.

Thereby, the first two parameters—colour band and required relative current or light level in this colour band—are requirements of the projection system. The lamp voltage is a lamp-dependent parameter, which, as explained above, determines the shape of the light arc and therefore the source etendue, whereas the system etendue is a fixed parameter of the projection system.

In a further preferred method, which is particularly exact, waveshape correcting functions are used, which depend at least step-wise (over regions) on time constants that describe the physical behaviour of the discharge process. With the aid of such waveshape correcting functions, in particular, corrections can be carried out in steep transitions from one light power level to another light power level. This is, in particular, advantageous because extremely steep edges in the waveshape are generally beneficial in time-sequential grey-scale rendering.

The method according to the invention, and the driving unit according to the invention, can be used, in particular, with a projection system described in the beginning, which operates with a time-sequential colour rendering approach. Furthermore, the method and the driving unit according to the invention can be used to advantage in other types of projection system.

Generally, the invention might be used for all types of discharge lamps, particularly high-pressure discharge lamps. Preferably, it is used for HID lamps, particularly UHP lamps.

Other objects and features of the present invention will become apparent from the following detailed descriptions considered in conjunction with the accompanying drawings. It is to be understood, however, that the drawings are designed solely for the purposes of illustration and not as a definition of the limits of the invention. In the drawings, wherein like reference characters denote the same elements throughout:

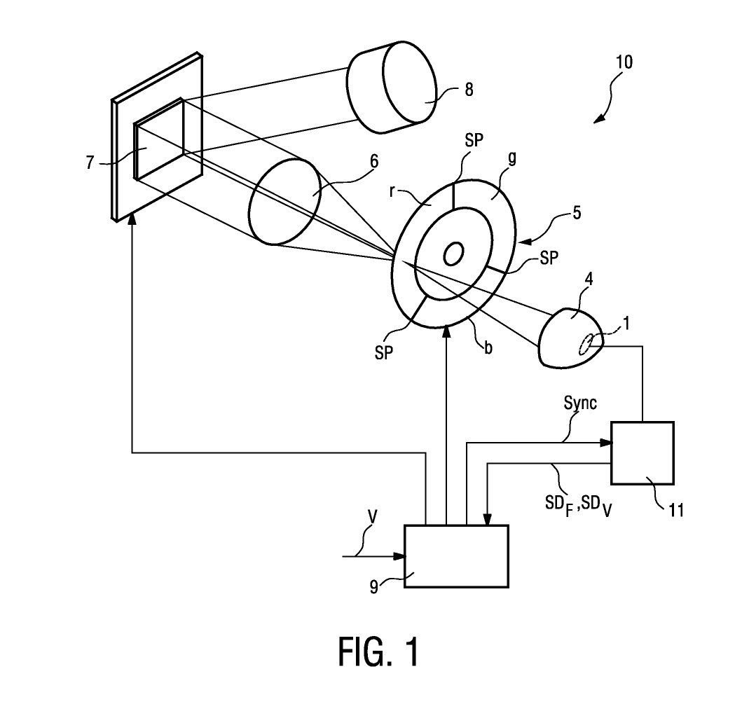

FIG. 1 shows a schematic representation of an embodiment of a projector system according to the invention;

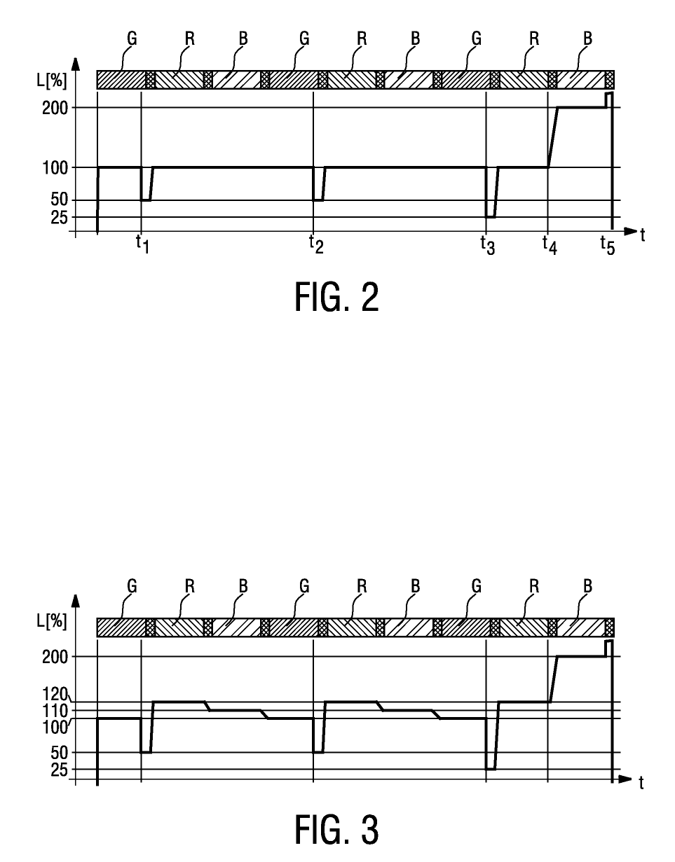

FIG. 2 shows a target light waveshape according to a first embodiment;

FIG. 3 shows a target light waveshape according to a second embodiment;

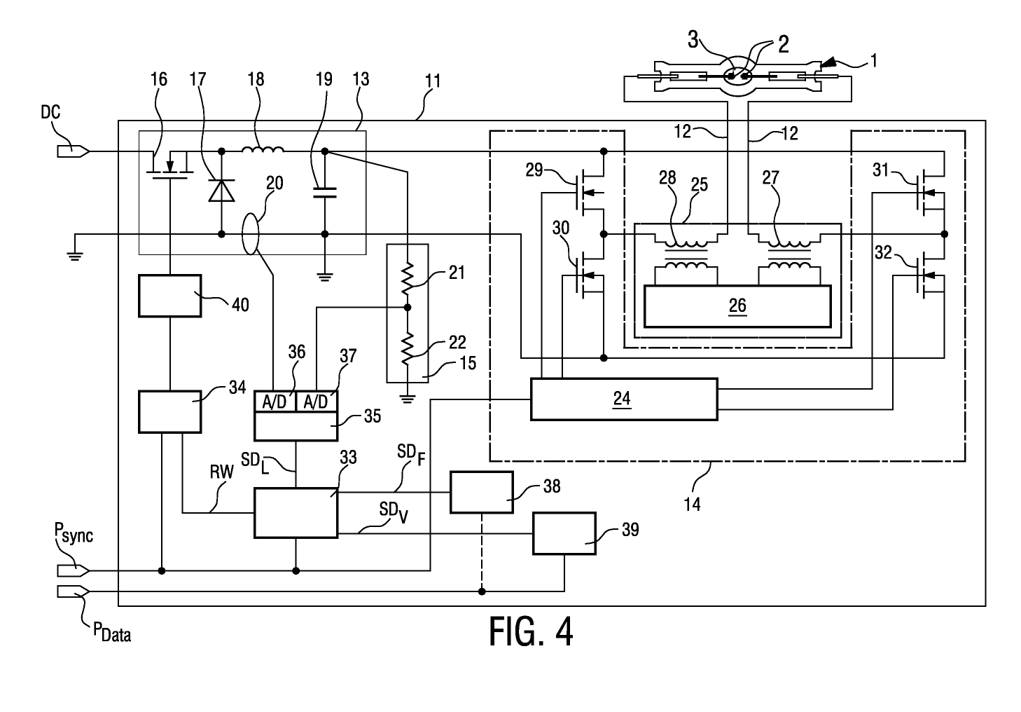

FIG. 4 shows a block diagram of a lamp driving unit according to the invention;

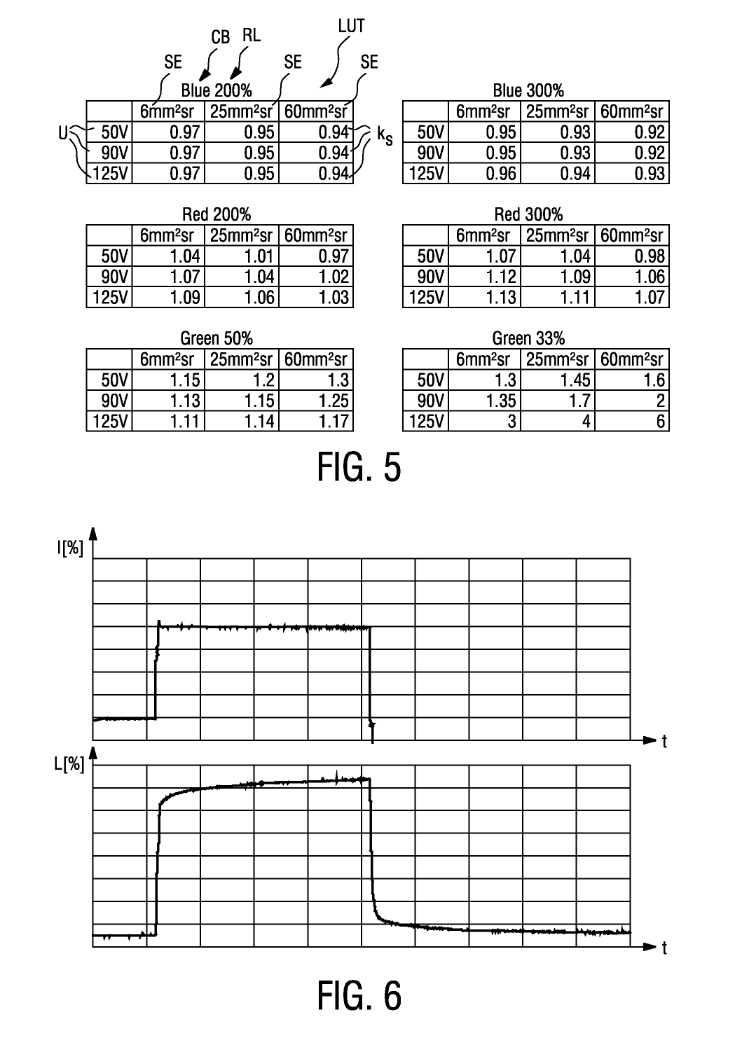

FIG. 5 shows lookup tables comprising correcting factors for different colour bands and required relative light output;

FIG. 6 shows a current pulse (upper curve) and the resulting light pulse (lower curve), under application of a waveshape correcting function according to the invention;

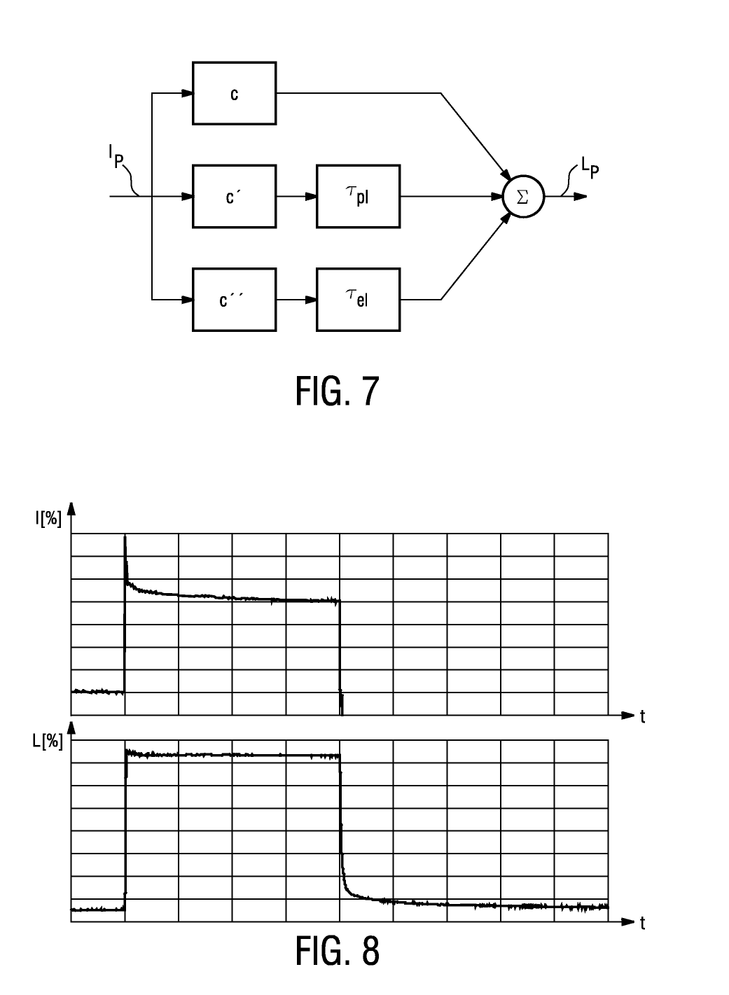

FIG. 7 shows a schematic diagram to illustrate the behaviour of a step in light intensity as a result of a step in lamp current.

FIG. 8 shows a current pulse (upper curve) and the resulting light pulse (lower curve), under application of a waveshape correcting function according to the invention.

The dimensions of the objects in the figures have been chosen for the sake of clarity and do not necessarily reflect the actual relative dimensions.

FIG. 1 shows a basic construction of a projector system 10 using time-sequential colour rendering, in which the different colours—red, green and blue—are rendered one after the other, whereby distinct colours are perceived by the user owing to the reaction time of the eye.

Thereby, the light of the lamp 1 is focussed within a reflector 4 onto a colour wheel 5 with colour segments red r, green g, and blue b. For the sake of clarity, only three segments r, g, b are shown. Modern colour wheels generally have six segments with the sequence red, green, blue, red, green, blue. Spokes SP, or transition regions, are found between the segments r, g, b. This colour wheel 5 is driven at a certain pace, so that either a red image, a green image, or a blue image is generated. The red, green, or blue light generated according to the position of the colour wheel 5 is then focussed by a collimating lens 6, so that a display unit 7 is evenly illuminated. Here, the display unit 7 is a chip upon which is arranged a number of miniscule moveable mirrors as individual display elements, each of which is associated with an image pixel. The mirrors are illuminated by the light. Each mirror is tilted according to whether the image pixel on the projection area, i.e. the resulting image, is to be bright or dark, so that the light is reflected through a projector lens 8 to the projection area, or away from the projector lens and into an absorber. The individual mirrors of the mirror array form a grid with which any image can be generated and with which, for example, video images can be rendered. Rendering of the different brightness levels in the image is effected with the aid of a pulse-width modulation method, in which each display element of the display apparatus is controlled such that light impinges on the corresponding pixel area of the projection area for a certain part of the image duration, and does not impinge on the projection area for the remaining time. An example of such a projector system is the Duo®-System of Texas Instruments®.

Naturally, the invention is not limited to just one kind of projector system, but can be used with any other kind of projector system.

FIG. 1 also shows that the lamp 1 is controlled by a lamp driving unit 11, which will be explained later in detail. This lamp driving unit 11 is in turn controlled by a central control unit 9. Here, the central control unit 9 also manages the synchronisation of the colour wheel 5 and the display apparatus 7. A signal such as a video signal V can be input to the central control unit 9 as shown in this diagram.

FIGS. 2 and 3 show examples of ideal target light wave-shapes which should preferably be available in modern projection systems.

FIG. 2 shows a somewhat simpler version and FIG. 3 a more demanding version, in which an even better colour balance adjustment is possible. The light output is plottet over time as a percentage of the nominal light output (achieved by nominal lamp current), whereby exactly one lamp current half-wave is shown. Equally, synchronization with the individual colour bands green G, red R, blue B is shown. The spoke times ST are located between the individual colour bands G, R, B. These spoke times ST are the phases during which the colour on the display changes from one colour to the next. A corresponding synchronization between the colour wheel and the lamp driver follows, as described above, by means of the central control unit 9.

The projection system used in both examples is a DLP projector used for rear projection television. It uses a 6-segment colour wheel with a colour cycle of green, red, blue, green, red, blue (GRBGRB). To improve the colour mixing by the human eye, this wheel is rotated three times each video frame. The video frame rate is usually 60 Hz, sometimes 50 Hz for European TV. The lamp frequency is synchronized accordingly, so it is also 50 Hz-60 Hz In each half-period of lamp current, there are 1.5 wheel rotations=3 colour cycles.

To improve the rendering of low-level shades, it may be possible to have short phases in the light waveshape with reduced light level at the end of each green segment. An optimum is to have a 50% level twice, and a 25% level once in each half-period, as shown in both diagrams.

Further, to improve the colour balance a boost in blue may be set, which is applied in the last blue segment each half period. The light level here should be 200%. This is also shown in both diagrams

An additional colour balance adjustment may be done by also changing the amplitude in the red and green segments (only FIG. 3).

After the boosted blue segment, depending on lamp age, there has to be an additional anti-flutter pulse, which is applied during the “spoke” time ST.

The modulation in usual projection systems is still based on the assumption that light is roughly proportional to current. This is acceptable for a first approach. However, to improve the system beyond this and to enable more simple transfer between different designs, a method and a lamp driving unit according to the invention should be used.

FIG. 4 shows a possible realisation of a driving unit 11 according to the invention.

This driving unit 11 is connected via connectors 12 with the electrodes 2 in the discharge chamber 3 of the gas discharge lamp 1. Furthermore, the driving unit 11 is connected to a power supply DC and to ground, and features an input P_{Sync} to receive a synchronisation signal from a higher-level control unit 9.

The driving unit 11 features also an additional input P_{Data} to receive system status data SD_{F}, SD_{V}, particularly fixed and variable settings of the projection system 10 from a higher-level control unit 9. The fixed settings SD_{F} can alternatively be programmed in the factory.

The driving unit 11 comprises a direct current converter 13, a commutation stage 14, an ignition arrangement 25, a current control unit 34, a voltage measuring unit 15, a current measuring unit 20, a lamp information unit 35, a first memory 38 and a second memory 39.

The commutation stage 14 comprises a driver 24 which controls four switches 29, 30, 31, 32. The ignition arrangement 25 comprises an ignition controller 26 (comprising, for example, a capacitor, an resistor and a spark gap), and an ignition transformer which generates, with the aid of two chokes 27, 28, a symmetrical high voltage so that the lamp 1 can ignite.

The converter 13 is fed by the external direct current power supply DC of, for example, 380 V. The direct current converter 13 comprises a switch 16, a diode 17, an inductance 18 and a capacitor 19. The current control unit 34 controls the switch 16 via a level converter 40, and thus also the current in the lamp 1. In this way, the actual lamp power is regulated by the current control unit 34.

The voltage measuring unit 15 is connected in parallel to the capacitor 19, and is realised in the form of a voltage divider with two resistors 21, 22. For voltage measurement, a reduced voltage is diverted at the capacitor 19 via the voltage divider 21, 22, and measured in the lamp information unit 35 by means of a first analog/digital converter 37. A capacitor (not shown in FIG. 4) may be connected in parallel to the resistor 22 to reduce high-frequency distortion in the measurement signal. The current in the lamp 1 is monitored in the lamp information unit 35 by means of the current measuring unit 20, which operates on the principle of induction, and a second analog/digital converter 37.

The lamp information unit 35 records and analyses the measurement values reported by the current measuring unit 20 and the voltage measuring unit 15, i.e. it monitors the voltage behaviour of the lamp driver 11 at the gas discharge lamp 1.

The lamp information unit 35 can calculate further lamp status data on the basis of the measured current and the measured voltage. For example, a measure of the momentary pressure in the lamp can be determined, as described above, on the basis of the current curve and the voltage curve. Furthermore, the separation of the electrodes, and therefore the size of the discharge arc, and therefore also the source etendue, can be determined from the momentary lamp voltage, which increases slowly with the age of the lamp.

These lamp status data SD_{L} are forwarded to the pattern calculation unit 33. The pattern calculation unit 33 also obtains the fixed settings SD_{F} of the projection system from the first memory 38. These are, for example, lamp type, reflector type, or construction data pertaining to the colour wheel. This information can be stored in the first memory 38, for example by means of the data input P_{Data} at start-up of the projection system, or at time of manufacture. The pattern calculation unit 33 obtains the variable settings SD_{V} of the projection system 10 from the second memory 39. These data are updated regularly via the data input P_{Data}, and comprise information such as the positive and negative pulse timing, the corresponding light level and colour, and the assigned placement for the anti-flutter pulse.

The pattern calculation unit 33 then uses these available data and calculates, using the method according to the invention, the most suitable current signal waveshape RW for a certain subsequent time, and forwards this to the current control unit 34, which regulates the lamp 1 accordingly.

The current control unit 34, the pattern calculation unit 33, the commutation stage 14 and the ignition arrangement 25 are all triggered by the external synchronization signal Sync received from the central control unit 9.

FIG. 5 illustrates how a calculation of the best current waveshape can be done relatively easily, in order to obtain, as precisely as possible, a certain target light waveshape, based on an example for which the simple target light waveshape LW_{T} shown in FIG. 2, is desired. The following parameters, obtained from fixed settings retrievable from the first memory 38, are taken into consideration:

The optical design of the projection system is characterized by its etendue E. Here, for example, the etendue is chosen to be E=20 mm²sr.

The filter design is characterized by the colour bands. Here, for example, the following values are assumed:

Red=605-695 nm, Green=505-570 nm, Blue=410-485 nm

The following parameters are deduced from variable settings, which can change slowly according to application or with the passage of time, and their momentary values in the memory 39:

Positions and levels of light waveshape together with colour segments, here, for example: 50% at time t₁ in green, 50% at t₂ in green, 25% at t₃ in green, 200% at t₄ . . . t₅ in blue. (see FIG. 2)

Additionally, as described above, the following information according to the lamp status is received from the lamp information unit 35 during operation of the lamp:

Electrode separation, which is a measure for the arc length and therefore also the source etendue. Here, for example, the lamp voltage U is measured, which is proportional to the electrode separation d: U=90V

In the easiest scenario, the light L is described as a function of the current I. For each part n of the waveshape this can be done by the simple formula (c.f. equation (1)):

I=L(I)/kₙ (3)

where kₙ is a correcting factor, according to a correcting function, which is determined in the pattern calculation unit 33.

The calculation is done for the present example with the aid of lookup tables LUT, as shown in FIG. 5. The correcting sample values kₛ stored in the look-up table, measured in a previous step, can de directly used as correcting factors kₙ in equation (3). Between these sampling values, interpolated values kₙ can be used. In the example of FIG. 5, the tables have four dimensions:

1. colour band CB

2. system etendue SE

3. lamp voltage U and

4. relative current level RL.

Only two-dimensional extracts from these four-dimensional look-up tables are shown in FIG. 5.

An excerpt from the table for the blue colour band at 200% light level for three different voltage values and three different values for the system etendue are shown in the upper left of the diagram. This excerpt can be used, for example, to generate the boost in the last blue segment according to the target light waveshape LW_{T} according to FIG. 2.

On the right is an excerpt from the table, also the blue segment, but with 300% light level. Below this are two corresponding tables for the red segment at 200% and 300% light level respectively. Below this again are two corresponding tables for the green segment at 50% (left) and 33% (right) light level respectively

As explained above, the part of the table shown in the upper left of FIG. 5 must be used to calculate the boost pulse in the blue segment for the target light waveshape LW_{T} according to FIG. 2, since a boost of 200% light level is to be generated here in the blue colour segment.

In this case we see that there is no dependency on the lamp voltage U, only on the etendue SE. So, for a given system with, for example, 25 mm²sr etendue SE the driver selects the rectify factor kₙ=0.95 and calculates the current required for 200% blue light as I[%]=200%/kₙ=210.5%.

A more complicated example is a similar boost pulse in the red colour band. Here, the left-hand table second from the top in FIG. 5 must be used.

According to this table, during lamp life, the driver has to adjust the current setting differently, starting with a correcting factor kₙ=1.01 at 50V lamp voltage U.

For implementation of the interpolated values for all lamp voltages U, a linear formula can be used. With the row of 25 mm²sr the kₙ can be expressed as:

kₙ(U)=0.98+U·6.67·10⁻⁴V⁻¹ (4)

A similar thing can be done for the interpolation of etendue SE. Here it is more likely to assume linearity with the square root of the value, so the interpolation would be:

kₙ(U,E)=1.03+6.67·10⁻⁴·(U/V)−1.13·10⁻²·(E/mm²ₛᵣ₎^{1/2} (5)

In this way one can also combine this to a formula for the light response in the 200% light pulse in red:

L(I[%],U,E)=1.03+6.67·10⁻⁴·(U/V)−1.13·10⁻²·(E/mm²sr) (6)

With this equation, for example, for U=110V, E=18 mm²sr, L=200% in red it is achieved:

L(I[%],U,E)=1.055·I (7)

Therefore, the current has to be set to 200%/1.055=189.5% to achieve a 200% red pulse.

More advanced solutions, also taking into account the transient behaviour, can be derived in the same general way. In particular, for steep pulses, a further problem arises in that the light does not exactly follow the current. A corresponding measurement is shown in FIG. 6. The upper curve shows, essentially, a square-wave current pulse I, and the curve below this is the resulting light pulse L. This diagram shows clearly that one cannot obtain an exactly square light pulse using an essentially square current pulse.

Closer analysis shows that here, three time constants are essentially effective, and ensure that the behaviour of the light pulse is delayed with respect to the current pulse. This is shown graphically in FIG. 7. The current pulse I_{P} is converted here to a light pulse L_{P}. The time constant for a first component c of the current pulse I_{P} is very short, so that one can assume the absence of a delay. The second component c′ arises as a result of the plasma behaviour, and has a time constant τₚ₁ of several tens of microseconds. The third component c″ results from the emission behaviour of the electrodes. These time constants τ_{c1} lie in the range of several milliseconds. By adding the three components c, c′, c″, as shown in FIG. 7, one can obtain quite a good description of the behaviour of the lamp. This description is different for each of the colour bands used. In the time domain, the light can be expressed as

L_{P}=I_{P}·(c+c′·[1−e^{-t/τ}^{ₚ₁}]+c″·[1−e^{-t/τ}^{ₑ₁}]) (8)

giving a correcting factor kₚ as follows

k_{P}=c+c′·[1−e^{-t/τ}^{ₚ₁}]+c″·[1−e^{-t/τe1}] (8)

with which the light can be divided to give the necessary value of current. FIG. 8 shows the result of a comparison measurement to the measurements of FIG. 6, whereby the current pulse here is corrected by the deduced correcting factor kₚ. As can be seen in FIG. 8, an essentially square light pulse can be achieved by appropriate correction of the current pulse.

The method can equally well be applied for the transition at the end of the pulse, or for negative pulses.

Specifically, a particularly precisely defined target light waveshape can be generated using a combination of the correcting factors or correcting functions, which take into consideration the time constants, and the simpler correcting functions described first. Therefore, the invention makes it possible to generate, with a high degree of precision, variable light levels at different times during each image frame, and therefore to improve the efficiency and grey-scale resolution.

Although the present invention has been disclosed in the form of preferred embodiments and variations thereon, it will be understood that numerous additional modifications and variations could be made thereto without departing from the scope of the invention. For the sake of clarity, it is also to be understood that the use of “a” or “an” throughout this application does not exclude a plurality, and “comprising” does not exclude other steps or elements. Also, a “unit” may comprise a number of blocks or devices, unless explicitly described as a single entity.

1. A method of driving a discharge lamp (1) in a projection system (10), wherein, in a feed-forward control process,
system status data (SD_{L}, SD_{F}, SD_{V}) comprising
static information pertaining to the design of the projection system and/or
dynamic information pertaining to the projection system and/or
dynamic information pertaining to the lamp operation
are obtained, and wherein,
based on the system status data (SD_{L}, SD_{F}, SD_{V}),
a momentary target light waveshape (LW_{T}, LW_{T′}) required by the projection system (10) and
a waveshape correcting function
are determined, and wherein
the actual current (I) of the discharge lamp (1) is regulated according to a momentary required waveshape (RW) which is determined based on the target light waveshape (LW_{T}, LW_{T′}) and the waveshape correcting function.

2. The method according to claim 1, wherein the system status data (SD_{L}) comprises data from the following data group:
lamp voltage (U), gas pressure of the lamp, electrode separation, electrode status, discharge arc attachment over time.

3. The method according to claim 1, wherein the system status data (SD_{V}) comprises information from the following group of variable system settings:
positive and negative pulse timing, light level (RL) and colour band (CB), allowed place for anti-flutter pulse.

4. The method according to claim 1, wherein the system status data (SD_{F}) comprises information from the following group of fixed system settings:
lamp type, reflector type, colour filter and/or modulator construction data, system etendue (SE).

5. The method according to claim 1, wherein
at least parts of a waveshape correcting function are generated by an interpolation between experimentally observed correcting sampling values (kₛ).

6. The method according to claim 1, wherein
a required lamp current (Iₜ) at a certain time (t) is calculated from the target light waveshape by means of a correcting factor (kₛ, kₙ, k_{P}).

7. The method according to claim 6, wherein,
a correcting factor (kₙ) is calculated by the waveshape correcting function.

8. The method according to claim 1, wherein
certain correcting factors (kₛ, kₙ) or at least parts of a waveshape correcting function depending on certain system status data are stored in a look-up-table (LUT).

9. The method according to claim 1, wherein the correcting factors (kₛ, kₙ) and/or at least parts of the waveshape correcting function are determined depending on the following system status parameter:
colour band (CB),
required relative current or light level (RL),
lamp voltage (U),
system etendue (SE).

10. The method according to claim 1, wherein
at least parts of the waveshape correcting function and/or correcting factors (k_{P}) depend on a number of time constants (τₚ₁, τₑ₁) describing the physical behaviour of the discharge process.

11. A driving unit (11) for driving a discharge lamp (1) in a projection system (10) in a feedforward control process, which driving unit comprises
a source (35, 38, 39) of system status data (SD_{L}, SD_{F}, SD_{V}), which system status data (SD_{L}, SD_{F}, SD_{V}) comprise
static information pertaining to the design of the projection system and/or
dynamic information pertaining to the projection system and/or
dynamic information pertaining to the lamp operation;
a pattern calculation unit (33) for determination of
a momentary target light waveshape (LW_{T}, LW_{T′}) required by the projection system (10) and
a lamp current correcting function
based on the system status data (SD_{L}, SD_{F}, SD_{V}); and
a current control unit (34) for regulating the actual current (I) of the discharge lamp (1) according to a momentary required waveshape (RW) which is determined based on the target light waveshape (LW_{T}, LW_{T′}) and the correcting function.

12. A driving unit according to claim 11, wherein
the source (35, 38, 39) of system status data (SD_{L}, SD_{F}, SD_{V}) comprises
a lamp information unit (35) for obtaining data (SD_{L}) pertaining the momentary status of the lamp (1);
a first storage mean (38) comprising fixed setting data (SD_{F}) of the projection system (10);
a second storage mean (39) comprising variable setting data of the projection system.

13. A projector system, comprising a high pressure discharge lamp (1) and a driving unit (11) according to claim 10.
